(19) United States
(12) Patent Application Publication
(10) Pub. No.: US 2006/0182044 A1
(43) Pub. Date: Aug. 17, 2006

(54) Method of managing interruptions in an ethernet ring

(75) Inventor: Werner Maisch, Neuffen (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Automation and Control GmbH

(21) Appl. No.: 11/336,462

(22) Filed: Jan. 20, 2006

(30) Foreign Application Priority Data
Jan. 22, 2005 (DE) 102005003060.2

(51) Int. Cl. H04L 12/28

(52) U.S. Cl. 370/258

(57) ABSTRACT

A method of dealing with interruptions in a data network with a ring structure, for example an Ethernet ring, in which requisition packets are transmitted by network nodes. adjacent an interrupted ring conductor to transfer the interruption manager function from a previous node to one of the two nodes adjoining the interruption. The function of interruption manager is thus dynamically passed from one node to another.

### FIELD OF THE INVENTION

My present invention relates to a method of managing interruption in a data network with a ring structure and to a data network managed by that method. More particularly the invention relates to the management of interruption in Ethernet rings.

### BACKGROUND OF THE INVENTION

Data networks can have a variety of structures, one of which is a ring structure in which each network node is connected with two neighboring network nodes by two so-called ring ports. The result is a physically closed ring. However, to prevent data packets which are forwarded in the network from circulating endlessly, one of the network nodes has the function of interruption managing and serves to block connection between its ring ports. The result is an interruption in the physical ring to convert the network into a structure which logically is of linear form. The advantage of this ring structure is that the case of an interruption in a data line between two network nodes, the network manager can clear its blockage and allow data flow between all network nodes to be restored in spite of the fact that the interruption location has moved. The network structure is then logically again of a line shape although there the nodes form line ends.

The network nodes forming the line ends are referred to herein as peripheral nodes. Such ring structures are widely used for automation purposes. Because of its tendency to restore function in the case of a failure of a ring connector, the interruption manager is also referred to as a redundancy manager.

One possible technique for controlling the interruption manager is disclosed in DE 198 10 587. The interruption manager here sends out test data packets through one ring port and tests whether they reach its second ring port. Should they not, the interruption manager determines that the ring has been interrupted in another location and in this case the interruption manager internally closes a connection between its two ring ports. The disadvantage of this solution is that the beginning of data traffic following the termination of the unwanted interruption can occur at different points in time. This is the case since the interruption manager has already interrupted data communication whereas the network nodes at both ends of the stretch to be regenerated have not been liberated so that the ring over this period has divided into two segments. In this case data from one network segment cannot travel through the other data network segment and vice versa.

Reference may be made to United States Patent Publication 2003/010 7987A1 which also discloses an interruption manager (see CH 688 215 A5 as well).

### OBJECTS OF THE INVENTION

It is the principal object of the present invention to provide an improved method of managing interruptions in a data network with a ring structure, especially so as to prevent a prolonged subdivision of the network into independent segments.

Another object is to provide an improved data network with such interruption management.

### SUMMARY OF THE INVENTION

These objects are achieved in a method which comprises:

(a) forming at least one of the network nodes as an interruption manager and interrupting the network at the one of the network nodes; and

(b) dynamically assigning a special functionality of interruption manager to the network nodes based upon transmission of requisition data packets to the nodes from at least one node adjacent an interrupted ring conductor.

The data network will then have a ring structure and at least two network nodes and at least one network node, as an interruption manager, will interrupt the ring structure, the network nodes assuming the function of interruption manager dynamically.

The network nodes of the ring network thus assume the functionality of interruption manager dynamically. A dynamic assignment of the interruption manager function is an assignment to any of the nodes during the course of operation based upon the location of an interruption in the ring conductor. In particular, in the method of the invention:

a peripheral node detects an interruption of a network ring conductor directly connected thereto;

the occurrence of the interruption is signaled by transmission of a requisition data packet to the remaining network or segment thereof;

one of the network nodes, upon receipt of the requisition packet, clears its address table, and assumes the function of interruption manager;

an interruption manager optionally provided in the network or a segment thereof transfers its special functionality to the requisition data packet and is restored to regular network node operation;

the two peripheral nodes of the network or network segment bargain as to which should assume the function of new interruption manager, the selected peripheral node assuming the function of new interruption manager;

upon one of the peripheral nodes detecting the regeneration of a network ring conductor directly connected thereto, signaling the regeneration to the network by sending out a regeneration data packet to the previously reachable network or network segment; and

upon receipt of the regeneration data packet, the peripheral node, which previously had the function of interruption manager, sending out a requisition data packet to release it from its function as the interruption manager.

With this invention, therefore, one network node always assumes the special function of interruption manager.

In the case of an interruption, this function transfers dynamically to a network node adjacent that interruption so that at all times the network node with the special function of interruption manager is the network node directly connected to an interrupted network ring conductor or one which has previously been interrupted. The network is reconfigured only after the failure of a ring conductor. The invention is especially applicable to an Ethernet network.

### BRIEF DESCRIPTION OF THE DRAWING

The above and other objects, features, and advantages will become more readily apparent from the following description, reference being made to the accompanying drawing in which:

FIGS. 1a through 1d are diagrams of an Ethernet network with a ring structure in various phases of the operation in accordance with the invention for an interrupted ring conductor; and

FIGS. 2a and 2b are similar illustrations of an Ethernet network in a ring structure in various phases of operation in accordance with the invention with two interrupted ring conductors.

### SPECIFIC DESCRIPTION

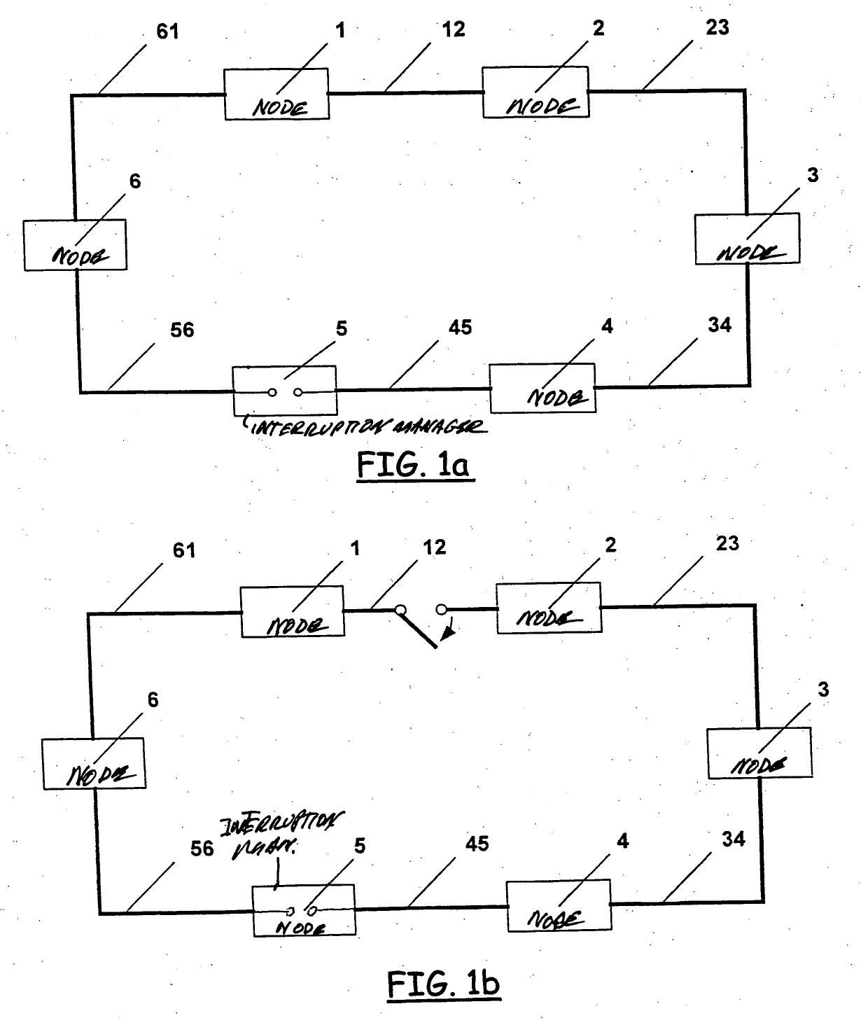

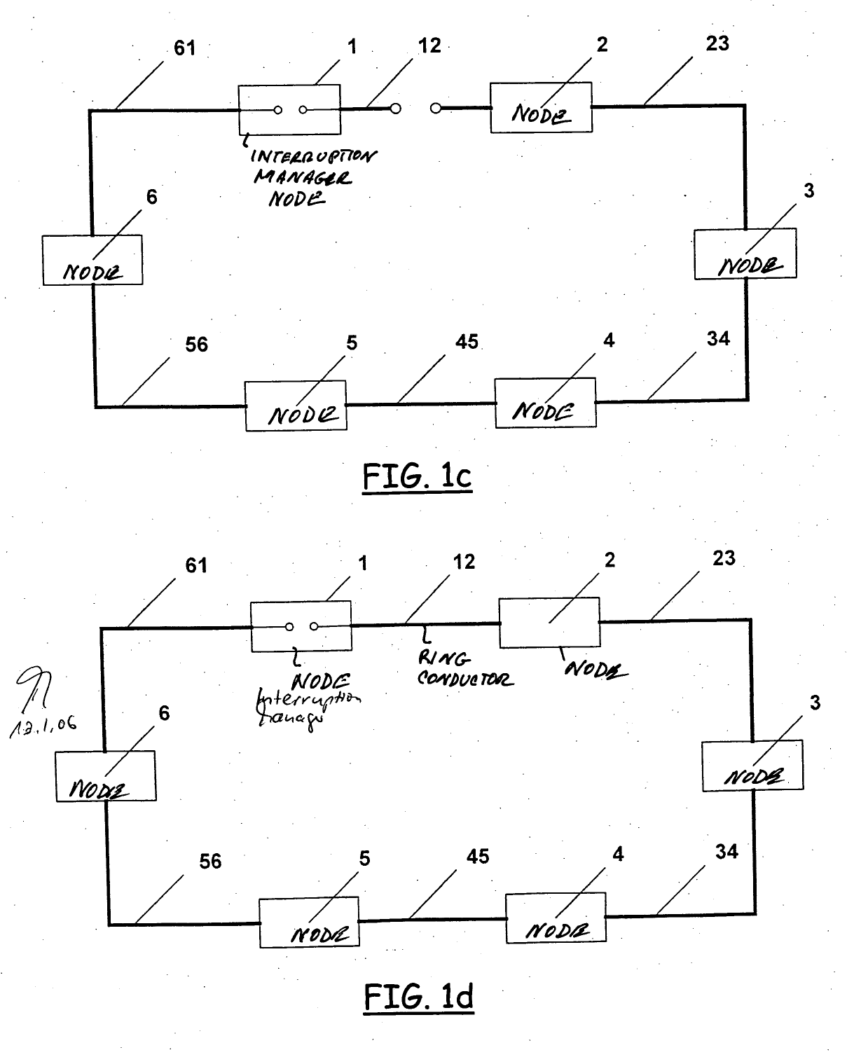

The drawing is intended to illustrate the method of dealing with interruptions in an Ethernet network with a ring structure. The network is comprised of at least two network nodes and at least one of the network nodes is constituted as an interruption manager for the ring structure. For example in FIGS. 1a through 1d it will be assumed, for the purpose of describing the method, that one of the peripheral nodes 1 recognizes or detects an interruption in a network ring conductor 12 directly connected therewith and signals the interruption with the aid of a requisition data packet to the remainder of the network or network segment.

One of the network nodes 2 to 6 responds by clearing its address table upon receipt of the requisition packet and eventually will assume the role of the interruption manager.

An internet manager 5 which is optionally provided in the network or network segment transfers to the requisition packet its special interruption managing function and resumes its operation as a regular network node.

The two peripheral nodes 1, 2 of the network or network segment bargain between them as to which one then should assume the role of new interruption manager and it will be assumed that the peripheral node 1 will then assume the functionality of interruption manager as a result of this bargaining.

A peripheral node 1, 2 detects the regeneration of the directly connected network ring conductor 12 and signals this regeneration to the network or network segment by sending out a regeneration packet to the previously reachable network or network segment. Upon receipt of the regeneration packet, a peripheral node 2,1 transmits a requisition packet which releases has been described.

In FIG. 1a, I have shown a network with a ring structure in its normal state. In this case, the network nodes 1 through 6, usually ethernet units, are connected in a ring by ring conductors 12, 23, 34, 45, 56 and 61. In the completely closed ring the data traffic is interrupted by the interruption manager, in this case the network node 5 in order to prevent repetitive circulation of the data in the ring. The node of the network which forms the interruption manager at the start of operations can be determined for example by a user but is not relevant to the present invention.

FIG. 1b shows the case in which the ring conductor 12 is interrupted between the network nodes 1 and 2. Since the network nodes 1 and 2 are no longer interconnected by both of their ring ports with the network and each can therefore form an end of a network which is logically a line, they can be referred to as peripheral or edge nodes. For each interruption, therefore, in a ring conductor there will be two such peripheral or edge nodes.

Network node 1 detects the interruption of the ring conductor 12 directly adjoining it and transmits via the ring conductor 61 a requisition data packet to the network or node segment.

The requisition packet is read by all of the network nodes, which dynamically clear the registry or their address tables. Network node 5, in addition, transfers its special function as interruption manager via the ring conductor 45. Analogously, the network 2 also transmits a requisition data packet, upon detection of the interruption in conductor 12 through the line 23 to the remainder of the network.

Since the network node 5 no longer represents an interruption, data traffic can pass through it and the two network nodes can communicate through the ring. They determine then which of these two peripheral nodes will assume the function of the interruption manager. For example, the bargaining as to is which shall become the interruption manager can be based upon the Ethernet-MAC addresses of the participating network nodes 1, 2.

In a preferred embodiment, the network node with the higher Ethernet-MAC address will assume the function of interruption manager. In the present example this is the network node 1 and thus in FIG. 1c it can be seen that even though the ring conductor 12 remains interrupted, the node 1 has assumed the function of interruption manager.

If, as in FIG. 1d, the interruption in ring conductor 12 is required, the continuous state is detected by the network nodes 1 and 2 and signaled by the transmission of respective regeneration data packets over the data lines 61 and 23, these regeneration packets reach the opposite peripheral node 2 or 1 and induce each of them to transmit a requisition packet with renewed bargaining as to which node will assume the interruption manager function if, for example, a number of ring conductors of the network have been interrupted.

In the case illustrated in FIG. 1d, there is no further interruption and network node 1 remains the interrupted handling node or interruption manager for the completely regenerated ring and blocks connection between its ring ports so as to provide the necessary interruption in the ring structure to prevent repeated circulation of the data traffic. The restoration of the network conductor 12 does not change the data traffic in the ring so that no recognition of the network is required. Reconfiguration is only necessary upon a permanent failure of a network ring conductor.

It should be clear that there is always one network node which assumes the special function of interruption manager and which is located directly at an interruption or previous interruption of the network ring conductor. This is not the case only when, at the outset of use of the network, no interruption in a conductor has occurred. The assignment of the special function to the network nodes can then be based upon action of the user or can pass automatically to the network node with the higher Ethernet-MAC address.

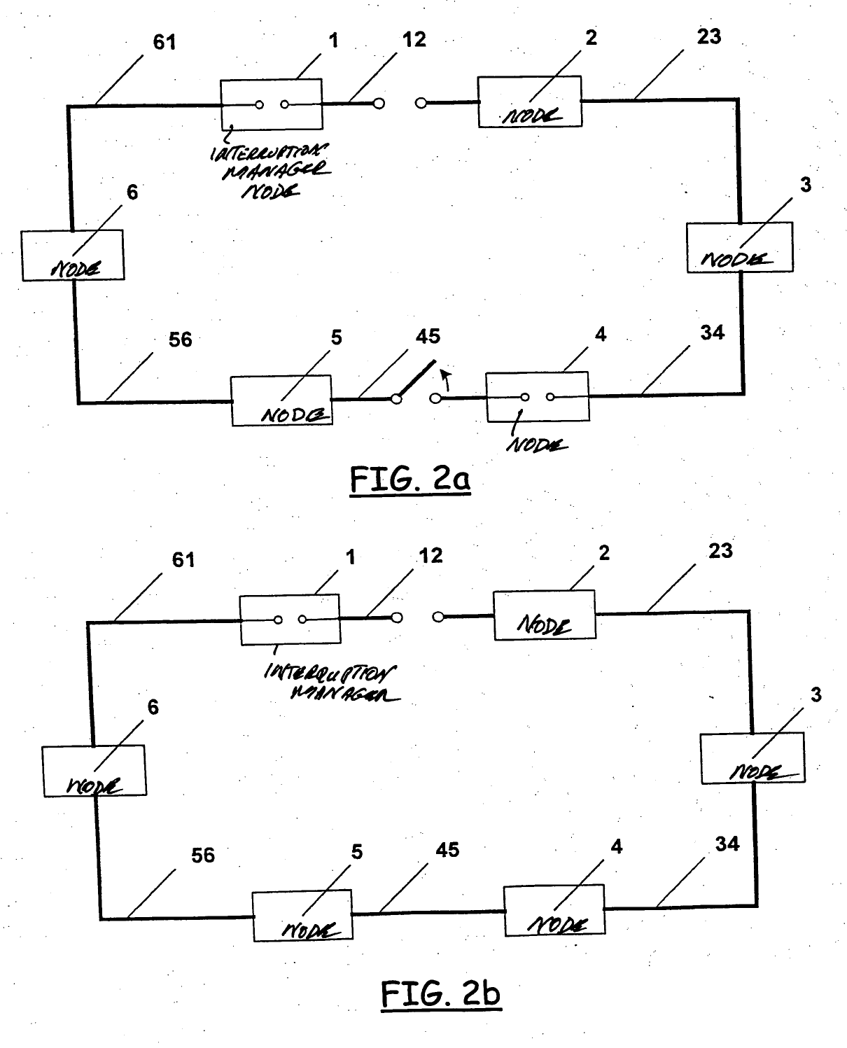

Another case, starts from the state shown in FIG. 1c in which the ring conductor 12 is interrupted and the network node 1 has been assigned the interruption manager function. In this situation, it can be assumed that another ring-conductor is interrupted, for example the ring conductor 45 (see FIG. 2a). In that case, the network node 5 sends a requisition data packet via ring conductor 56 through the remainder of the network and which is received by the network node 1 and interpreted. The network nodes 1 and 5 bargain as to which should assume the function of the interruption manager. In the present case this node is the network node 1. Analogously, the network node 4 also sends a recognition data packet which reaches the network node 2 and has between them, based upon the previously discussed considerations, the network node 4 will assume interruption manager status. This state has been illustrated in FIG. 2a. The ring in this case has become two separate ring segments in each of which the network nodes has assumed the function of interruption manager. As in the prior cases, in each of these segments, for each network node which receives the recognition packet, the address table is cleared to enable the actual network configuration to be rebuilt therein.

When the ring conductor 45 is restored to continuity the network node 5 transmits a regeneration data packet via line 56 to the remainder of the network while the network 4 transmits a regeneration packet via line 34 to the remainder of the network. These regeneration packets are received by the network nodes 1 and 2 which then transmit requisition packets to determine which of these peripheral nodes will assume the function of interruption manager.

The dynamic assignment of the functionality of interruption manager has the advantage that the user need not provide any separate apparatus to function as interruption manager. In addition, any reconfiguration of the ring can be effected only upon the failure of a segment thereof and not anew when the failure has been cured as a result, the blocking of data traffic through the ring will depend only upon a network node which has been assigned the interruption function and the interruption function is only transferred to a network node upon a new interruption in the ring conductors. As a result, further network nodes can be introduced into interrupted ring conductors and will immediately participate in the data traffic through the ring. The embodiments shown should not be considered as a limiting of the invention. The number and arrangement of the network nodes the ring conductors number and sequences of interruptions and restoration of the ring conductors can vary without any effect on the invention.

I claim:

1. A method of dealing with interruptions in a data network having a ring structure with at least two network nodes, comprising the steps of:
(a) forming at least one of said network nodes as an interruption manager and interrupting the network at said one of said network nodes; and
(b) dynamically assigning a special functionality of interruption manager to said network nodes based upon transmission of requisition data packets to said nodes from at least one node adjacent an interrupted ring conductor.

2. The method defined in claim 1 wherein the special functionality of interruption manager is always assumed by a network node which is located directly at an interrupted or previously interrupted network ring conductor.

3. The method defined in claim 2 wherein the network is only reconfigured after the failure of a network ring conductor.

4. The method defined in claim 3 wherein said network is an Ethernet network.

5. The method defined in claim 4 wherein:
a peripheral node detects an interruption of a network ring conductor directly connected thereto;
the occurrence of the interruption is signaled by transmission of a requisition data packet to the remaining network or segment thereof;
one of the network nodes, upon receipt of the requisition packet, clears its address table, and assumes the function of interruption manager;
an interruption manager optionally provided in the network or a segment thereof transfers its special functionality to the requisition data packet and is restored to regular network node operation;
the two peripheral nodes of the network or network segment bargain as to which should assume the function of new interruption manager, the selected peripheral node assuming the function of new interruption manager;
upon one of the peripheral nodes detecting the regeneration of a network ring conductor directly connected thereto, signaling the regeneration to the network by sending out a regeneration data packet to the previously reachable network or network segment; and
upon receipt of the regeneration data packet, the peripheral node, which prefiously had the function of interruption manager, sending out a requisition data packet to release it from its function as the interruption manager.

6. The method defined in claim 5 wherein upon the release of a network node from the function of interrupt manager, the Ethernet-MAC address of the participating network node is requisitioned.

7. The method defined in claim 6 wherein the network node with the higher Ethernet-MAC address assumes the function of interruption manager.

8. A data network with a ring structure and at least two network nodes and whereby at least one network node, as an interruption manager, interrupts the ring structure, the network nodes assuming the function of interruption manager dynamically.

9. The data network defined in claim 7 wherein the data network is an Ethernet network.
